(19) United States
(12) Patent Application Publication
(10) Pub. No.: US 2004/0262993 A1
(43) Pub. Date: Dec. 30, 2004

(54) Electrohydraulic braking system for motor vehicles

(76) Inventor: Hans-Jorg Feigel, Rosbach (DE)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 10/492,123

(22) PCT Filed: Oct. 4, 2002
(86) PCT No.: PCT/EP02/11171

(30) Foreign Application Priority Data
Oct. 12, 2001 (DE) 101 50 584.1
Oct. 12, 2001 (DE) 101 50 587.6
Jul. 19, 2002 (DE) 102 32 872.2

(51) Int. Cl. B60T 8/34

(52) U.S. Cl. 303/155; 303/113.4

(57) ABSTRACT

In order to impart to the vehicle operator the usual feeling at the brake pedal in an electrohydraulic brake system of the ‘brake-by-wire’ type or ensure a pre-selected flexibility of the brake pedal by means of an electrically controllable valve assembly, the invention discloses that the electrically controllable valve assembly is formed of the separating valve, a pressure regulating or control valve connected to the outlet side of the separating valve and having its outlet port connected to the pressure fluid reservoir, as well as further valves that allow applying the pressure introduced into at least one wheel brake and/or the pressure generated by the pressure source to the pressure chamber of the master brake cylinder.

### TECHNICAL FIELD

The present invention generally relates to electrohydraulic braking systems for motor vehicles and more particularly relates to an electrohydraulic braking system for motor vehicles, actuatable in a ‘brake-by-wire’ mode of operation both by the vehicle operator and independently of the vehicle operator.

### BACKGROUND OF THE INVENTION

A brake system of this type is generally disclosed in international patent application WO 98/31576. In the prior art brake system, the device for adjusting the flexibility of the brake pedal includes a first pedal travel valve and a second pedal travel valve, wherein one of the pedal travel valves is arranged between the master brake cylinder and the suction side of a pump associated with the pressure source or a low-pressure accumulator, and the other one of the pedal travel valves is arranged between the master brake cylinder and the pressure side of the pump or a high-pressure accumulator associated with the pressure source. The electronic control and regulating unit is designed for controlling the two pedal travel valves in dependence on an application of the brake pedal, the said pedal travel valves being configured as proportional travel or pressure valves.

The comparatively great number of control valves entailing considerable expenditure and energy requirement is considered a disadvantage of the prior-art brake system.

### BRIEF SUMMARY OF THE INVENTION

In view of the above, an object of the invention is to provide a reliably operating brake system of the type initially mentioned with a reduced number of the necessary control valves or propose a brake system that offers the same comfort and can be realized with reduced expenditure and energy requirement.

This object is achieved by the present invention in that the electrically controllable valve assembly is provided by the separating valve, a pressure regulating or control valve connected to the outlet side of the separating valve and having its outlet port connected to the pressure fluid reservoir, as well as further valves, which permit applying the pressure introduced into at least one wheel brake and/or the pressure generated by the pressure source to the pressure chamber of the master brake cylinder.

To render the idea of the invention more precise, it is arranged for that the separating valve is configured as a normally open (NO) two-way/two-position directional control valve with analog control, while the pressure control valve is configured as a normally closed (NC) two-way/two-position directional control valve with analog control. Alternatively, the control valve connected to the outlet side of the separating valve can be designed as a normally closed (NC) on-off valve.

In another favorable embodiment of the object of the invention, the valves allowing application of the pressure introduced into at least one wheel brake to the pressure chamber (4) of the master brake cylinder are the outlet valves connected to the outlet side of the first separating valve and associated with the individual wheel brakes.

It is especially favorable when the valves that permit applying the pressure generated by the pressure source to the pressure chamber of the master brake cylinder are the inlet valves associated with the individual wheel brakes and the outlet valves.

In another favorable variant of the object of the invention, a pressure control valve of analog control is interposed between the pressure source and the pressure chamber of the master brake cylinder.

An advantageous improvement of the object of the invention provides that the inlet valves associated with the wheel brakes are configured as normally closed (NC) two-way/two-position directional control valves.

In another favorable improvement of the object of the invention, the outlet valves associated with the wheel brakes are configured as normally open (NO) two-way/two-position directional control valves.

In another aspect of the invention, where the master brake cylinder is designed as a tandem master cylinder, to the second pressure chamber of which a second brake circuit is connected by the intermediary of a second separating valve, the outlet ports of the outlet valves associated with the second brake circuit and the outlet port of the second separating valve are connectable to the pressure fluid reservoir by way of an electrically actuatable on-off valve. Further, it is especially expedient when a pressure control valve with a relief pressure function is connected between the outlet port of the pressure source and the first separating valve, said pressure control valve allowing a controlled application of the pressure generated by the pressure source to the pressure chamber of the master brake cylinder when the first separating valve is open.

Another advantageous aspect of the object of the invention arranges for a pressure control valve of analog control to be interposed in the connection between the pressure source and the inlet side of the inlet valves.

To achieve a favorable energy balance in the brake system of the invention, in particular in the bottom pressure range, a hydraulic-mechanical means is provided between the master brake cylinder and the separating valve, permitting a pre-selected flexibility of the brake pedal in the ‘brake-by-wire’ mode of operation.

Further details, features, and advantages of the invention can be taken from the following description of three embodiments by making reference to the enclosed schematic drawings, wherein like components have been assigned like reference numerals. In the drawings,

### BRIEF DESCRIPTION OF THE DRAWINGS

FIG. 1 shows the design of the brake system of the invention according to a first embodiment in the inactive or de-energized condition.

FIG. 2 shows the design of a second embodiment of the brake system of the invention in the inactive or de-energized condition.

FIG. 3 shows the design of a third embodiment of the brake system of the invention in a representation corresponding to FIG. 1 or 2.

### DETAILED DESCRIPTION OF THE PREFERRED EMBODIMENTS

The brake system of the ‘brake-by-wire’ type only represented in the drawings includes an actuating unit 2 operable by means of an actuating pedal designated by reference numeral 1 that is essentially composed of a dual-circuit pressure generator or master brake cylinder 3 and a non-pressurized pressure fluid reservoir 6. The master brake cylinder 3, in turn, includes two pressure chambers 4, 5 separated from each other and being in communication with the pressure fluid reservoir 6. A wheel brake 7 associated with the right front wheel of the motor vehicle and a wheel brake 8 associated with the left rear wheel of the motor vehicle are connected to the first pressure chamber (primary pressure chamber) 4 to which a pressure sensor 13 is connected by means of a closable first hydraulic line 11. Line 11 is closed by means of a first separating valve 9, which is preferably configured as an electromagnetically operable, normally open (NO) two-way/two-position directional control valve of analog control. The outlet side of the first separating valve 9 is connected to the pressure fluid reservoir 6 by means of a hydraulic connecting line 16 in which an electromagnetically operable, normally closed (NC) two-way/two-position directional control valve 17 of analog control is inserted. The first separating valve 9 and the two-way/two-position directional control valve 17 of analog control form an electrically controllable device which permits a pre-selected flexibility of the brake pedal 1 in the ‘brake-by-wire’ mode of operation and, thus, imparts the usual brake pedal feeling to the driver.

The second pressure chamber 5 of the master brake cylinder 2 is connectable to the other pair of wheel brakes 14, 15 associated with the right rear wheel of the motor vehicle and the left front wheel of the motor vehicle by way of a second hydraulic line 12 closable by means of a second separating valve 10. The second separating valve 10 is configured as an electromagnetically operable, normally open (NO) on-off valve, whose outlet side is connectable to the pressure fluid reservoir 6 by the intermediary of a likewise electromagnetically operable, normally open (NO) on-off valve 18. In all other respects, the design of the hydraulic circuit connected to the second pressure chamber 5 of the master brake cylinder 2 is identical to the brake circuit 11 that has been explained in the preceding description so that it need not be discussed in the following text.

As can be taken from the drawings in addition, a motor-and-pump assembly 20 with a high-pressure accumulator 21 is used as an auxiliary pressure source, said assembly, in turn, comprising a pump 23 driven by means of an electric motor 22. The suction side of the pump 23 is connected to the inlet side of the above-mentioned pressure control valve 17 or the outlet side of the first separating valve 9 by way of a non-return valve 34. The outlet of the high-pressure accumulator 21 is connected by way of a pressure-limiting valve 24 to a line portion 31 that connects the first separating valve 9 to the two-way/two-position directional control valve 17 of analog control. The fill condition of the high-pressure accumulator 21 is monitored by means of a travel sensor 25 (only represented).

A third hydraulic line 26 connects the pressure side of the pump 23 or the outlet of the high-pressure accumulator 21 to the inlet side of two electromagnetically operable, preferably normally closed (NC) two-way/two-position directional control valves or inlet valves 27, 28 of analog control, said valves being connected upstream of the wheel brakes 7 and 8 serving to build up hydraulic pressure in these wheel brakes. Two electromagnetically operable, preferably normally open (NO) two-way/two-position directional control or outlet valves 29, 30 of analog control are used to decrease the hydraulic pressure introduced into the wheel brakes 7,9, the outlet ports of said valves being connected to the above-mentioned line portion 31. In addition, a pressure sensor 32 is associated with the wheel brake 7 and aids in determining the hydraulic pressure that prevails in the wheel brake 7. An electronic control and regulating unit ECU 34 is used for the actuation of the motor-and-pump assembly 20, the above-mentioned valves 9, 10, 17, 18, 27, 28, 29, 30 and the pressure control valves associated with the second brake circuit 12. In particular the output signals of the pressure sensors 13, 32, of the travel sensor 25 and a brake-request acquisition device 33 that is preferably designed redundantly and associated with the master brake cylinder 3 are sent to said ECU.

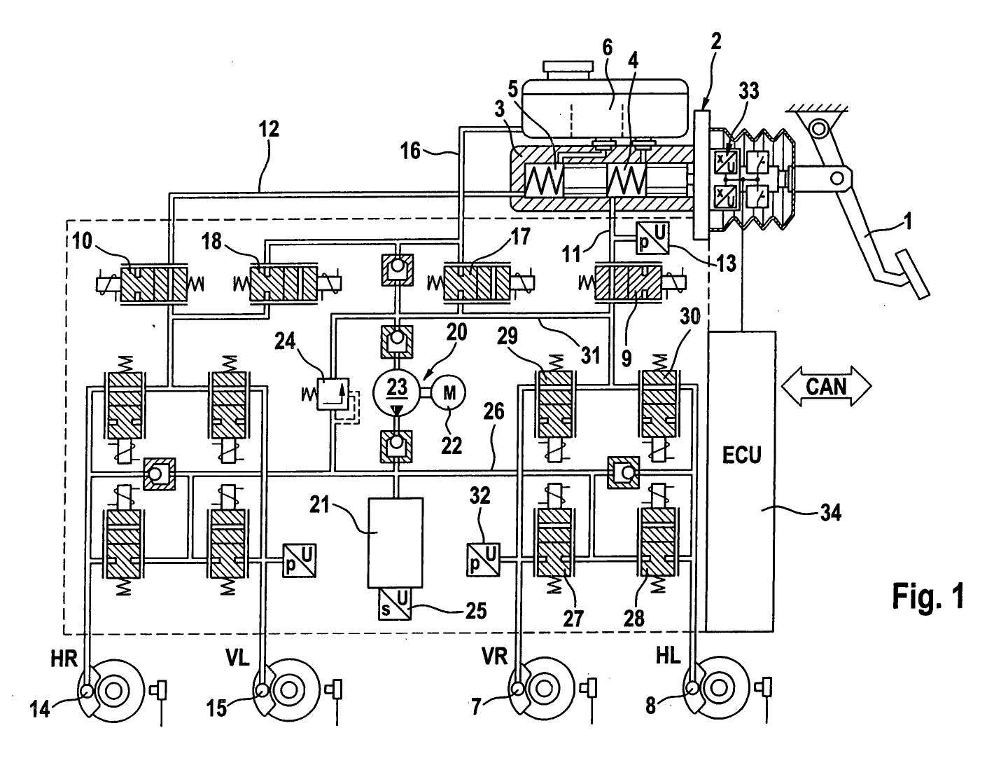

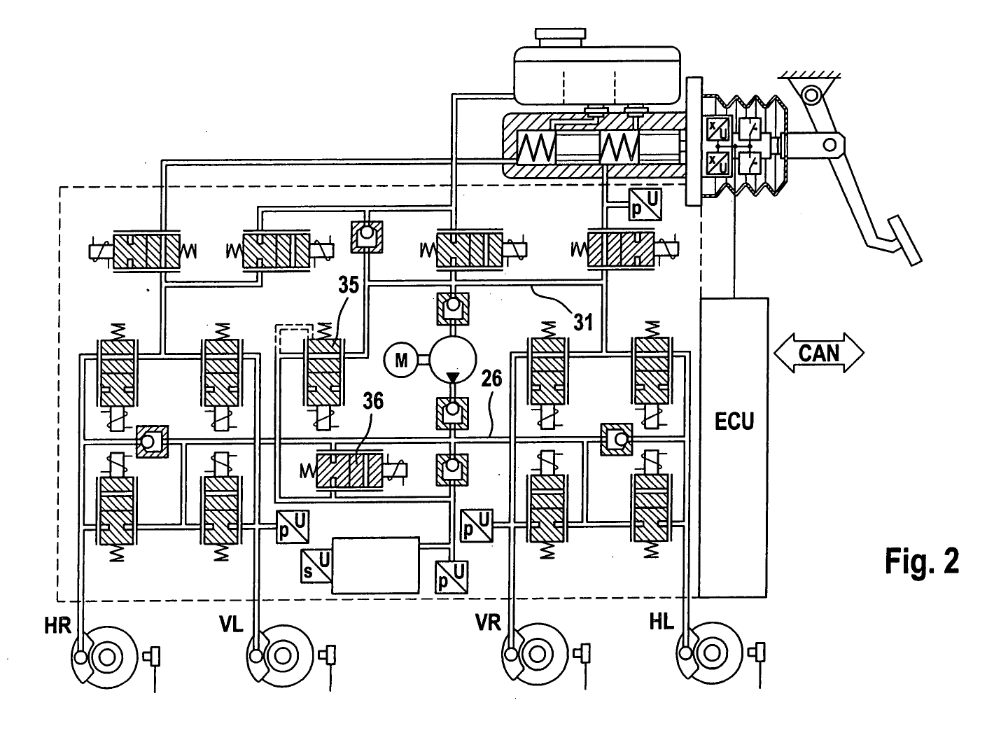

In the second design of the electrohydraulic brake system of the invention as illustrated in FIG. 2, a two-way/two-position directional control valve 35 with pressure relief function of analog control is interposed between the outlet of the high-pressure accumulator 21 and the line portion 31 mentioned in connection with FIG. 1. Besides, a normally closed (NC) two-way/two-position directional control valve 36 of analog control is provided between the outlet of the high-pressure accumulator 21 and the hydraulic line 26, said valve allowing a purposeful application of a defined pressure fluid volume to the wheel brakes 7, 9 when a pressure, equal zero is adjusted in line 26. The pressure values determined by pressure sensors 32 may then be evaluated for detecting gases disposed in the system.

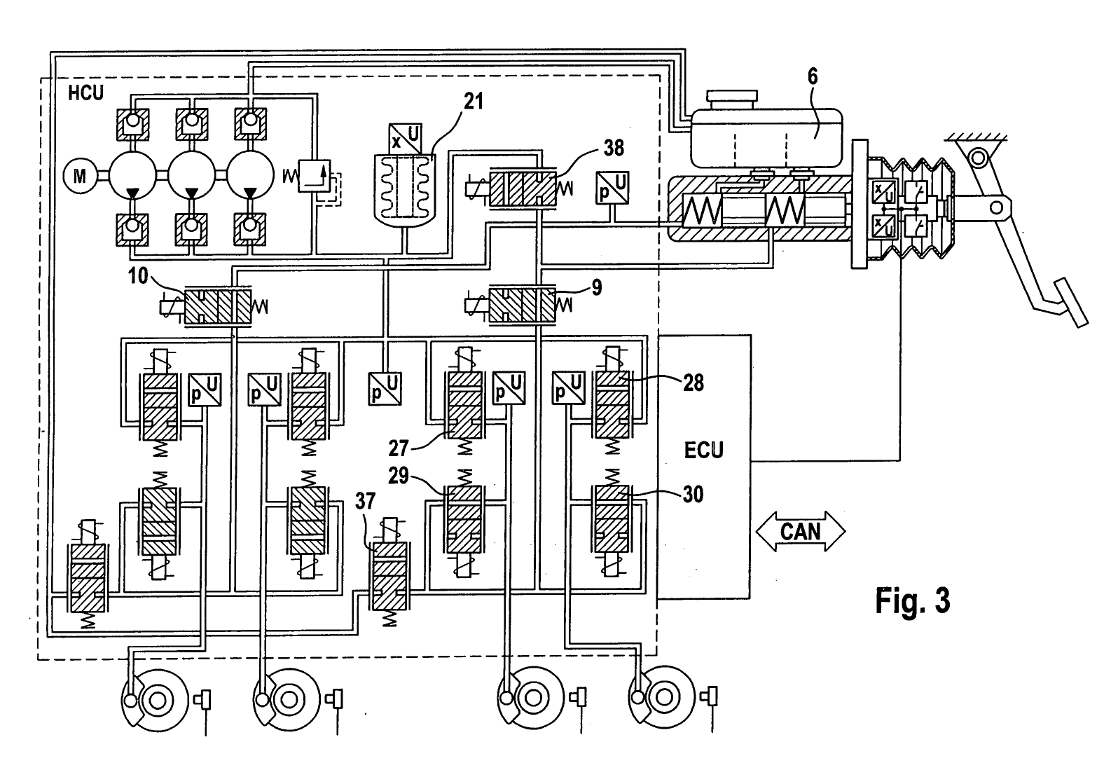

Finally, both separating valves 9, 10 associated with the pressure chambers 4, 5 of the master brake cylinder 2 are designed as normally open (NO) two-way/two-position directional control valves with analog control in the third embodiment shown in FIG. 3. The outlets of the separating valves 9, 10 are connected to the outlet side of the outlet valves 29, 30, on the one hand, and to the pressure fluid reservoir 6 by way of normally closed on-off valves 37, on the other hand. Besides, the outlet of the high-pressure accumulator 21 is connected to the first pressure chamber 4 of the master brake cylinder 2 by way of a normally closed (NC) two-way/two-position directional control valve 38 of analog control.

The mode of function of the brake system of the invention illustrated in FIG. 1 is explained in detail in the following text.

In the non-depressed condition of brake pedal 1 all components assume their positions shown in the drawings, corresponding to the non-energized condition or standby condition. When in the preferred brake-by-wire mode of operation the brake pedal 1 is depressed or a pressure-increase phase initiated, the brake-request acquisition device 33 will produce control signals being sent to the above-mentioned electronic control unit 34. Unit 34 produces actuating signals used to switch over the separating valves, pressure control valves and on-off valves described in the preceding text. These actuating signals serve for controlled activation of the first separating valve 9, for closing the second separating valve 10 and opening the pressure control valve 17. The on-off valve 18 remains closed which is arranged in the connection between the outlet side of the outlet valves associated with the second brake circuit 12 and the pressure fluid reservoir 6. Simultaneously all outlet valves 29, 30 are closed and all inlet valves 27, 28 opened so that the pressure delivered by the high-pressure accumulator 21 is applied to the wheel brakes. Displacement of a pressure fluid volume through the first separating valve 9 activated in controlled manner and the open pressure control valve 18 into the pressure fluid reservoir 6 imparts a pedal feeling to the drive that corresponds to the pedal feeling of a conventional brake system.

A phase of maintaining the pressure constant is initiated by switching the inlet valves 27, 28 over into their closed position.

The inlet valves 27, 28 are closed and the corresponding outlet valves 29, 30 opened in a controlled way during pressure reduction. Besides, the valves 17, 18 arranged in the lines that lead to the pressure fluid reservoir 6 are also opened.

In a release operation, initially the pressure fluid volume consumed in the wheel brakes 7, 8 is used to reset the master cylinder pistons. As this occurs, said pressure fluid volume flows through the now open outlet valves 29, 30 and the opened separating valve 9 into the first pressure chamber 4 of the master brake cylinder 2. Because this volume is not sufficient in some cases to fully reset the master cylinder piston, the inlet valves 27, 28 will be opened as well so that pressure fluid volume can be supplied additionally from the high-pressure accumulator 21. Using the volume out of the wheel brakes is favorable under energetic aspects.

The release operation takes place similarly also in the embodiment according to FIG. 3. The above-mentioned on-off valves 37 are closed for this purpose, and the replenishment of the pressure fluid volume provided by the high-pressure accumulator 21 takes place through the pressure control valve 38 in a controlled manner, with inlet valves 27, 28 closed. The outlet valves 29, 30 are opened at the same time.

In the event of power failure e.g. caused by a battery defect, a short-circuit or switch-off of the ignition, the brake system of the invention will automatically change over to a fallback mode of operation rendering braking operations by the driver possible. As this occurs, the separating valves 9, 10 and the outlet valves 29, 30 are switched to assume the inactive switch position shown in the drawing so that a hydraulic connection between the master brake cylinder 3 and the wheel brakes is opened, through which pressure increase can take place.

1-13. (Canceled)

14. Electrohydraulic braking system for motor vehicles, actuatable in a brake-by-wire mode of operation both by the vehicle operator and independently of the vehicle operator, comprising:
a master brake cylinder operable by a brake pedal and having at least one pressure chamber, in communication with one or more vehicle wheel brakes,
a non-pressurized pressure fluid reservoir,
a hydraulic pressure source actuatable by an electronic control and regulating unit, wherein said one or more wheel brakes are connected to the master brake cylinder by means of at least one connection closable by a separating valve and respectively associated with each of said one or more wheel brakes are pressure control valves or inlet and outlet valves that are actuatable by the electronic control and regulating unit and connect the wheel brakes to the pressure source or the pressure fluid reservoir,
a valve assembly electrically controllable by the electronic control and regulating unit which permits a pre-selected flexibility of the brake pedal by opening a valve device in a ‘brake-by-wire’ mode of operation, wherein the electrically controllable valve assembly is provided by the separating valve,
a pressure regulating or control valve connected to an outlet side of the separating valve and having an outlet port connected to the pressure fluid reservoir, wherein the pressure regulating or control valve transfers the pressurized fluid introduced into said one or more wheel brakes or the pressurized fluid generated by the pressure source to the pressure chamber of the master brake cylinder.

15. Electrohydraulic brake system as claimed in claim 14, wherein the separating valve is configured as a normally open (NO) two-way/two-position directional control valve of analog control.

16. Electrohydraulic brake system as claimed in claim 14, wherein the pressure control valve connected to the outlet side of the separating valve is configured as a normally closed (NC) two-way/two-position directional control valve of analog control.

17. Electrohydraulic brake system as claimed in claim 14, wherein the control valve connected to the outlet side of the separating valve is designed as a normally closed (NC) on-off valve.

18. Electrohydraulic brake system as claimed in claim 14, wherein the valves allowing an application of the pressure introduced into said one or more wheel brakes to the pressure chamber of the master brake cylinder include the outlet valves connected to the outlet side of the first separating valve and associated with the individual wheel brakes.

19. Electrohydraulic brake system as claimed in claim 14, wherein the valves that permit applying the pressure generated by the pressure source to the pressure chamber of the master brake cylinder are the inlet valves associated with the individual wheel brakes and the outlet valves.

20. Electrohydraulic brake system as claimed in claim 14, further including a pressure control valve of analog control is interposed between the pressure source and the pressure chamber of the master brake cylinder.

21. Electrohydraulic brake system as claimed claim 14, wherein the inlet valves associated with the wheel brakes are configured as normally closed (NC) two-way/two-position directional control valves.

22. Electrohydraulic brake system as claimed in claim 14, wherein the outlet valves associated with the wheel brakes are configured as normally open (NO) two-way/two-position directional control valves.

23. Electrohydraulic brake system as claimed in claim 14, wherein the master brake cylinder is designed as a tandem master cylinder, having first and second pressure chamber, wherein a second separating valve is connected between said second pressure chamber and a second brake circuit, wherein the outlet ports of the outlet valves associated with the second brake circuit and the outlet port of the second separating valve are connectable to the pressure fluid reservoir by way of an electrically actuatable on-off valve.

24. Electrohydraulic brake system as claimed in claim 14, wherein a pressure control valve with a relief pressure function is connected between the outlet port of the pressure source and the first separating valve, said pressure control valve allowing a controlled application of the pressure generated by the pressure source to the pressure chamber of the master brake cylinder when the first separating valve is open.

25. Electrohydraulic brake system as claimed in claim 14, wherein a pressure control valve of analog control is interposed in the connection between the pressure source and the inlet side of the inlet valves.

26. Electrohydraulic brake system as claimed in claim 14, wherein a hydraulic-mechanical means is provided between the master brake cylinder and the separating valve, permitting a pre-selected flexibility of the brake pedal in the ‘brake-by-wire’ mode of operation.
